(19) United States
(12) Patent Application Publication
(10) Pub. No.: US 2010/0043030 A1
(43) Pub. Date: Feb. 18, 2010

(54) RECORDATION OF PROGRAM SERIES

(75) Inventor: Scott White, Austin, TX (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T Intellectual Property I, L.P., Reno, NV (US)

(21) Appl. No.: 12/192,697

(22) Filed: Aug. 15, 2008

(51) Int. Cl. G06F 3/00; H04N 7/26; H04N 7/173

(52) U.S. Cl. 725/58; 386/124; 725/131; 386/E05.001

(57) ABSTRACT

Methods, systems and computer-readable media to provide recordation of program series are disclosed. A method of recording programs includes obtaining a record type indication related to a program series from a user via an electronic program guide. The method also includes accessing a watched list of episodes of the program series from a memory of a set top box (STB) device to determine episodes of the program series that the user has not seen. Episodes of the program series that the user has not seen include episodes of the program series that are marked as not watched or episodes that have not been added to the watched list. The method further includes recording at least one episode of the program series based on the determination and updating the watched list to mark that the at least one episode has been recorded.

### TECHNICAL FIELD

The present application relates generally to recordation of program series via a set top box device/digital video recorder (STB/DVR) device.

### BACKGROUND

Current STB/DVR devices allow a user to record program series, which include a number of episodes. Some STB/DVR devices offer the user a capability to record all episodes of a program series, or provide the user with choices to limit the scope of what is recorded. For example, the user may choose to record only new episodes, or new episodes and rerun episodes. In another example, the user may limit recording of the program series to one or more television channels.

### BRIEF DESCRIPTION OF THE DRAWINGS

Some embodiments are illustrated by way of example and not limitation in the figures of the accompanying drawings in which:

FIG. 1 is block diagram of an example video distribution system to provide a program series;

FIG. 2 depicts a display of an example electronic program guide portion and an action interface related to a program series of the electronic program guide portion;

FIG. 3 is an example record type interface of a program series;

FIG. 4 is an example watched list related to a program series;

FIG. 5 is a flowchart that illustrates an example method of processing a user action related to a program series of the electronic program guide;

FIG. 6 is a flowchart that illustrates an example method of recording at least one episode of a program series;

FIG. 7 is a flowchart that illustrates an example method of restoring a watched list and redelivering at least one episode of a program series;

FIG. 8 is an example embodiment of an Internet Protocol Television system that may be used to provide program series content and redelivery thereof to at least one set top box device; and

FIG. 9 is a block diagram of an illustrative embodiment of a general computer system.

### DETAILED DESCRIPTION

Systems, methods and computer-readable storage media to provide recordation of program series are disclosed. In the following description, for the purposes of explanation, numerous specific details are set forth in order to provide a thorough understanding of example embodiments. It will be evident, however, to one skilled in the art, that an example embodiment may be practiced without all of the disclosed specific details.

In accordance with a particular embodiment, a method of recording programs via a set top box (STB) is disclosed. The method includes obtaining a record type indication related to a program series from a user via an electronic program guide (EPG) and accessing a watched list of episodes of the program series from a memory of the STB device to determine episodes of the program series that the user has not seen. The episodes of the program series that the user has not seen include episodes of the program series that are marked as not watched or episodes that have not been added to the watched list. The method further includes recording at least one episode of the program series based on the determination and updating the watched list to mark that the at least one episode has been recorded.

In accordance with another embodiment, a set top box device to record a program is disclosed. The set top box device includes a memory to store episodes of a program series, the memory to further store a watched list associated with the episodes of the program series. The set top box device also includes an episode manager configured to obtain a record type indication related to the program series from a user via an electronic program guide, to access the watched list associated with episodes of the program series from the memory to determine episodes of the program series that the user has not seen, and to update the watched list to mark at least one episode of the program series when it is recorded. The episodes of the program series that the user has not seen include episodes of the program series that are marked as not watched or episodes that have not been added to the watched list. The set top box device further includes a video recording module to record the at least one episode of the program series based on the episode manager determining episodes of the program series that the user has not seen.

In accordance with yet another embodiment, there is provided a computer-readable storage medium. The computer-readable storage medium includes operational instructions that, when executed by a processor, cause the processor to obtain a record type indication related to a program series from a user via an electronic program guide and access a watched list of episodes of the program series from a memory of an STB device to determine episodes of the program series that the user has not seen. The episodes of the program series that the user has not seen include episodes of the program series that are marked as not watched or episodes that have not been added to the watched list. The computer-readable storage medium also includes operational instructions that, when executed by a processor, cause the processor to record at least one episode of the program series based on the determination and update the watched list to mark that the at least one episode has been recorded.

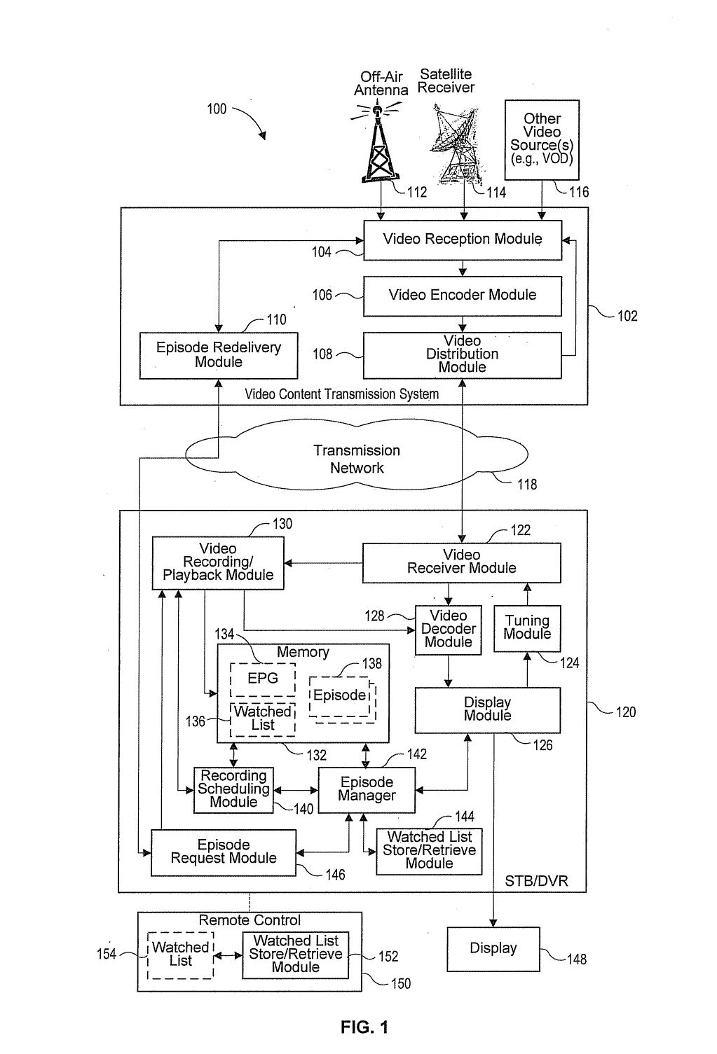

FIG. 1 is block diagram of an example video distribution system 100 to provide a program series. The video distribution system 100 includes a video content transmission system 102, one or more video content sources 112, 114 and 116, a transmission network 118, and a set top box (STB)/digital video recorder (DVR) device 120. Although one video content transmission system 102 and one STB/DVR device 120 are shown and described for clarity and brevity, the video distribution system 100 may include multiple video content transmission systems 102, with each video content transmission system 102 servicing multiple STB/DVR devices 120. The transmission network 118 enables communication between the video content transmission system 102 and the STB/DVR device 120.

The transmission network 118 may include one or more of a long haul transport network (e.g., a gigabit Ethernet network, an Asynchronous Transfer Mode (ATM) network, a frame relay network), a wireless network (e.g., a satellite network, a Wi-Fi network, or another wireless network), other public or private networks, or any combination thereof. The transmission network 118 may also include connections, such as fiber to the home (FTTH), fiber to the node (FTTN), telephone (e.g., digital subscriber line (DSL)), coaxial cable, hybrid fiber/coaxial, wireless or any other combination thereof. The foregoing is not exhaustive and alternate or additional networks as well as connections may be employed to interconnect the video content transmission system 102 to the STB/DVR device 120.

The video content transmission system 102 is configured to service one or more STB/DVR devices 120 with video content (e.g., program series video content). The video content transmission system 102 includes a video reception module 104, a video encoder module 106, a video distribution module 108, and an episode redelivery module 110.

The video reception module 104 receives video content, such as video broadcasts, multicasts, and other video transmissions, from multiple video sources, including an off-air antenna 112, a satellite receiver 114, or one or more other video sources 116 (e.g., fiber feed sources, video servers and tape machines, which serve video content). The video content received by the video reception module 104 may be in a variety of formats, including the National Television System Committee (NTSC) format, the Advanced Television Systems Committee (ATSC), the Moving Pictures Experts Group (MPEG)-2 and MPEG-4 formats, the Digital Video Broadcasting (DVB) format, the Windows Media format, baseband digital format, and other available formats.

The video encoder module 106 cooperates with the video reception module 104 to provide the video content received by the video reception module 104 to the video distribution module 108 in a standardized format. More specifically, the video reception module 104 may decode and may further convert the video content received in the aforementioned different formats into a standardized format. In turn, the video encoder module 106 may further encode the video content provided in the standardized format into a digital format for distribution of the video content. For example, the digital format may be MPEG-2, MPEG-4, or another digital media format. The video distribution module 108 is configured to distribute or transmit the video content to the STB/DVR device 120.

The episode redelivery module 110 is configured to receive an episode redelivery request from the STB/DVR device 120. Further, based on the redelivery episode request, the episode redelivery module 110 is configured to request a video source, such as video on demand source 116, to transmit a program episode related to the episode redelivery request. Upon receipt of the program episode, the episode redelivery module 110 is further configured to transmit the program episode related to the redelivery episode request to the STB/DVR device 120.

The STB/DVR device 120 is configured to receive video content, including program series video content, distributed from the video content transmission system 102 for display and for recording. The STB/DVR device 120 includes a video receiver module 122, a tuning module 124, a display module 126, a video decoder module 128, a video recording/playback module 130, and a memory 132 that may maintain an electronic program guide (EPG) 134, a watched list 136 and one or more episodes of a program series. The STB/DVR device 120 further includes a recording scheduling module 140, an episode manager 142, a watched list store/retrieve module 144 and an episode request module 146.

The STB/DVR device 120 is also configured to receive input from a remote control device 150 and to display video content via a display device 148. The remote control device 150 includes a watched list 154 that is a copy of the watched list 136 stored in the memory 132 of the STB/DVR 120. The remote control device 150 includes a watched list store/retrieve module 152 that is configured to store a copy of the watched list 136 from the STB/DVR 120 as watched list 154. The watched list store/retrieve module 152 is further configured to transmit the copy of the watched list 154 to the STB/DVR 120.

The video receiver module 122 is configured to receive video content, including program series video content, distributed or transmitted from the video content transmission system 102, including video content from the plural video sources 112, 114 and 116. The tuning module 124 is configured to receive a channel selection from a user via the remote control device 150 and is configured to instruct the video receiver module 122 to request video content associated with the selected channel from the content transmission system 102.

The video decoder module 128 is configured to decode video content from the video receiver module 122 (received in response to the request for video content of selected channel) or video content from video recording/playback module 130 for display on the video display device 148 via the video display module 126. The display module 126 is configured to receive video content from the video decoder module 128, and is further configured to display the video content via the display device 148 coupled to the STB/DVR device 120.

The video recording/playback module 130 is configured to receive video content, such as program series video content from the video receiver module 122 or program series video content that is redelivered from the video content transmission system 102 via the episode redelivery module 110. The video recording/playback module 130 is further configured to record the received program series video content to the memory 132 of the STB/DVR device 120 as episodes 138.

The electronic program guide (EPG) 134 may periodically (e.g., every two weeks) or at certain times be updated by the video content transmission system 102 via a separate process (not shown). The EPG 134 may maintain data about the video content (e.g., program series video content) that may be received by the STB/DVR 120. For example, the data may include a date and a time for each episode of a program series, a channel associated with the episode, a description of the episode, and an indication of whether the episode is a new episode or repeat episode. The watched list 136 may maintain data about episodes of a certain program series, or episodes of multiple program series. Alternatively, multiple watched lists 136 for each program series may be stored in memory 132. For example, for each episode the watched list 136 may include a program series title, an episode number of the episode, a summary of the episode and plural indicators related to the episode. The indicators may include a recordation indicator that indicates whether the episode has been recorded to the memory 132, a percentage watched indicator that indicates whether at least a portion of the episode has been watched by a user, and an added indicator that indicates whether the episode has been added by the user to the watched list 136.

The recording scheduling module 140 is configured to schedule the recording of one or more episodes 138 of a particular program series from the EPG 134 in accordance with the watched list 136 for the particular program series. The episode manager 142 is configured to interface the user's input relating to recording the particular program series to the recording scheduling module 140. The episode manger 142 is also configured to store a copy of the watched list 136 outside the STB/DVR 120, such as to the remote control device 150, and to restore a copy of the watched list 154 from the remote control device 150 to the memory 132 via the watched list store/retrieve module 144. The episode manager 142 is further configured to request redelivery of an episode of the particular program series from the video content transmission system 102 to the memory 132 via the episode request module 146. Also, the episode manager 142 is configured to display a listing of episodes 138 that are recorded, to allow the user to select a recorded episode 138, and to instruct the recording/playback module 130 to play the selected episode to the display device 148 via the display module 126.

The watched list store/retrieve module 144 is configured to receive a store request from the episode manager 142 to store or save a copy of the watched list 136 to a memory (not shown) of the remote control device 150. In response to the store request, the watched list store/retrieve module 144 establishes wireless contact (e.g., via infrared or another wireless technology) with the watched list store/retrieve module 152 of the remote control device 150 and transmits the watched list 136 to the watched list store/retrieve module 152 for storage as watched list 154. The watched list store/retrieve module 144 is further configured to receive a restore request from the episode manager 142 to restore the watched list 136 of memory 132, such as in an event of loss of the watched list 136. In response to the restore request, the watched list store/retrieve module 144 establishes contact with the watched list store/retrieve module 152 of the remote control device 150, requests the copy of the watched list 154, and upon receipt, transmits the copy of the watched list 154 to the episode manager 142 for storage into memory as watched list 136.

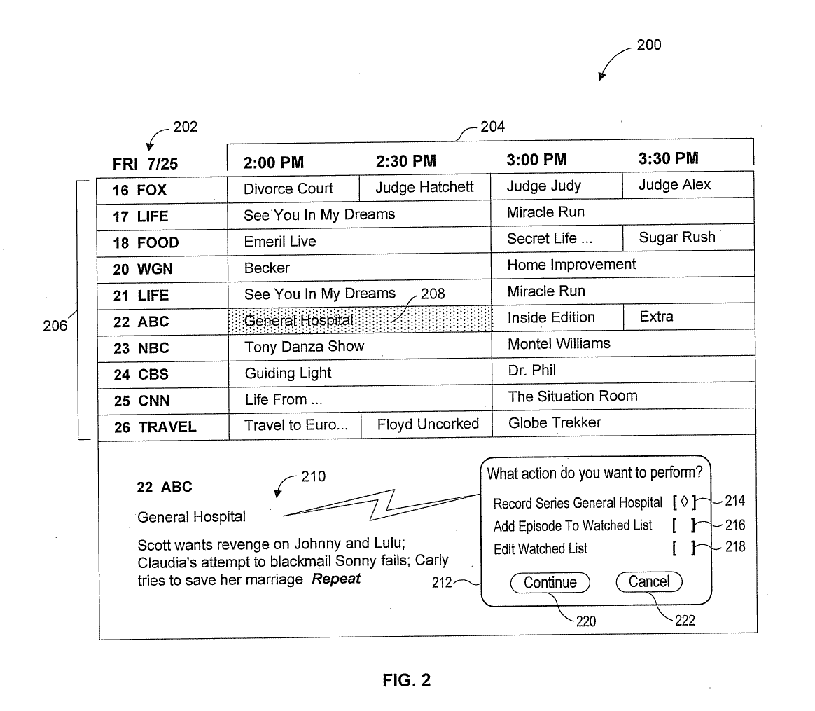

With reference to the operation of the STB/DVR device 120, while browsing through the EPG 134, the user may select an episode of a program series. A description associated with the episode is displayed to the user in a portion of the EPG 134. The description may indicate whether the episode is a new episode or a rerun episode. Using the remote control device 150, the user may select a button or a function related to one or more actions that the user can perform for the episode or the program series. The selection of the button instructs the episode manager 142 to display an action interface related to the program series to the user. An example action interface is illustrated in FIG. 2. The action interface enables the user to select an option for recording the program series, an option to add the episode to the watched list 136, and an option to edit the watched list.

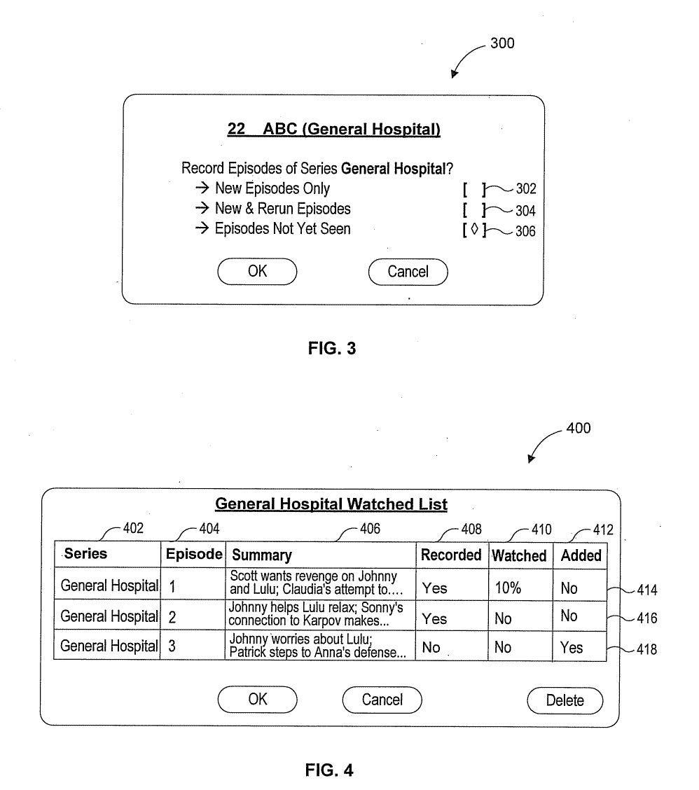

If the selected option indicates that the user would like to record the program series, the episode manager 142 displays a record type interface. An example record type interface is illustrated in FIG. 3. The record type interface enables the user to select which episodes of the program series the user would like to record. For example, the user may select to record only new episodes, new and rerun episodes (e.g., all episodes), or episodes not yet seen. Episodes not yet seen include those episodes of the program series that are indicated in the watched list 136 as not having been watched, at least partially, by the user or those episodes of the program series that have not been added to the watched list 136 by the user.

The episode manager 142 sends an indication of the selected program series and an indication of the record type to the recording scheduling module 140. The recording scheduling module 140 schedules for recording those episodes of the program series from the EPG 134 that are not indicated as having been seen in the watched list 136. More specifically, for each episode of the program series in the EPG 134, the recording scheduling module 140 determines from the watched list 136 whether that episode has not been watched, at least partially, by the user or whether that episode has not been added to the watched list 136 by the user. An indication in the watched list 136 that the episode has been at least partially watched or an indication that the episode has been added blocks the recording scheduling module 140 from scheduling that episode for recording and its subsequent recording by the video recording/playback module 130. After a negative determination as to indications that the episode has been watched or added, the recording scheduling module 140 instructs the video recording/playback module 130 to record the episodes of the program series scheduled for recording by the recording scheduling module 140. The video recording/playback module 130 may notify the recording scheduling module 140 upon recording of an episode as episode 138. In turn, the recording scheduling module 140 may notify the episode manager 142. The episode manger 142 may then update the watched listed 136 with the episode of the program series and may further indicate that the episode has been recorded. An example indication that the episode has been recorded is illustrated in FIG. 4.

Further with regard to the action interface options, if the selected option indicates that the user would like to add the selected episode to the watched list 136, the episode manager 142 may then access the watched list 136 to update the watched list 136 with the selected episode of the program series (e.g., episode entry for selected episode) and may further indicate that the episode has been added by the user. An example indication that the episode has been added is illustrated in FIG. 4. The addition of the selected episode of the program series to the watched list 136 blocks the recording scheduling module 140 from scheduling for recording the added episode of the program series.

Additionally with regard to the action interface options, if the selected option indicates that the user would like to edit the watched list 136, the episode manager 142 may access the watched list 136 to display the watched list 136 to the user and may allow the user to update the watched list 136. The user may be enabled to change one or more indications for an episode or to delete the episode from the watched list 136. For example, the user may change an indication of a partially watched episode to an indication that the episode has not been watched. As another example, the user may delete an episode that has been added by the user. Deleting the episode that has been indicated as added allows the recording scheduling module 140 to schedule for recording the added episode of the program series.

Further with reference to the operation of the STB/DVR device 120, if the episode manager 142 cannot access the watched list 136 when add episode or edit watched list actions are selected from the action interface options, the episode manager 142 may restore the watched list 136 from a memory outside the STB/DVR 120, such as to the remote control device 150. The episode manager 142 may request the watched list store/retrieve module 144 to retrieve a stored copy of the watched list 136 from the remote control device 150. The watched list store/restore module establishes wireless contact (e.g., infrared) with the watched list store/retrieve module 152 of the remote control device 150 and requests the copy of the watched list 154. Upon receipt of the copy of the watched list, the episode manger 142 stores the copy as watched list 136 and accesses the watched list to perform the action selected by the user (e.g., add episode to watched list or edit watched list).

Additionally with reference to the operation of the STB/DVR device 120, if the video recording/playback module 130 cannot play an episode 138 selected by the user via the episode manager 142, the episode manager 142 determines whether that episode was at least partially watched by the user from the watched list 136. If the episode was at least partially watched, the episode manager 142 requests the episode request module 146 to request redelivery of the episode from the video content transmission system 102. The episode request module 146 requests the episode redelivery module 110 of the video content transmission system 102 to redeliver the episode to the STB/DVR 120. The episode redelivery module 110 requests a video on demand source 116 to transmit the episode, and upon receipt, the episode redelivery module 110 transmits the episode related to the STB/DVR device 120. The episode request module 146 transmits the redelivered episode to the episode manager 142 and the episode manager 142 stores the redelivered episode as episode 138 in the memory 132 of the STB/DVR 120. The episode manager 142 then instructs the video recording/playback module 130 to play the redelivered and stored episode 138 to the user.

The modules 122-146 of the STB/DVR device 120 may be implemented in hardware, firmware or software. More specifically, dedicated hardware implementations, such as application specific integrated circuits, programmable logic arrays and/or other hardware devices, may be constructed to implement the functionality of one or more of modules 122-146. Alternatively or in addition, one or more of the modules 122-146 may be implemented in software. The software may be stored in the memory 132 and executed by a processor (not shown). Also, one or more of the modules 122-146 may be implemented in firmware.

FIG. 2 is a display of an example electronic program guide (EPG) portion 200 and an action interface 212 related to a program series of the EPG portion 200. Upon selection of an electronic program guide button or function by the user via the remote control device 150, the display module 126 may display the EPG portion 200 of EPG 134 stored in memory 132 to the user on the display device 148 for a current date 202. The displayed EPG portion 200 may include video content, including program series episodes, for a predetermined number of channels 206 (e.g., channel 16 through channel 26) and for a block of time 204 (e.g., from 2:00 PM to 3:330 PM).

The user may highlight a program series episode 208 (e.g., “General Hospital”) by using, for example, the remote control device 150. Upon highlighting the program series episode 208, a description 210 therefor may be displayed on the display device 148. The description of the episode 210 may indicate whether the episode is a new episode or a rerun episode. The user may scroll through the video content of the EPG 134 using the remote control device 150. Upon selecting an action button or function of the remote control device 150 for a selected program series episode (e.g., episode 208), an action interface 212 is displayed via display device 148. The action interface 212 may include one or more action entries, including an action 214 to record the program series associated with the selected episode 208, an action 216 to add the selected episode 208 to the watched listed 136, and an action 218 to edit the watched list 136. The user may continue with a selected action via button 220 or may cancel the action interface 212 via button 222.

FIG. 3 is an example record type interface 300 of a program series. The record type interface 300 may be displayed when the user selects action 214 from the action interface 212 of FIG. 2. The record type interface 300 provides one or more record types to record episodes of a program series. The record type interface 300 may include a record type to record only new episodes 302, a record type to record new and rerun episodes 304, and a record type to record episodes not yet seen 306. As described herein, the episodes not yet seen may include those episodes of the program series that are indicated in the watched list as not having been watched, at least partially, by the user or those episodes of the program series that have not been added to the watched list by the user.

FIG. 4 is an example watched list 400 related to a program series. The watched list 400 may be displayed when the user selects action 218 to edit the watched list from the action interface 212 of FIG. 2, or an entry may be added to the watched list 400 when the user selects action 216 to add the selected episode 208 to the watched list 400. An episode entry of the example watched list 400 includes a program series title 402, an episode number associated with the episode 404, a summary of the episode 406, and one or more indicators 408-412 related to the episode. The indicators may include a recorded indicator 408 that indicates whether the episode has been recorded to the memory, a watched indicator 410 that indicates whether the episode has been watched, and if so, what percentage of the episode has been watched, and an added indicator 412 that indicates whether the episode has been added to the watched list 400 by the user. The watched list 400 includes three (3) example episode entries 414-418. Episode entry 414 indicates that episode number 1 has been recorded and the user has watched a 10% portion of the recorded episode. Episode entry 416 indicates that episode number 2 has been recorded, but has not been watched or added. Episode entry 418 indicates that episode number 3 has not been recorded or watched, but has been added by the user to the watched list 400. Episodes that are marked as partially watched (e.g., episode 416) or added (e.g., episode 418) may be used by the STB/DVR 102 to block recording of these episodes.

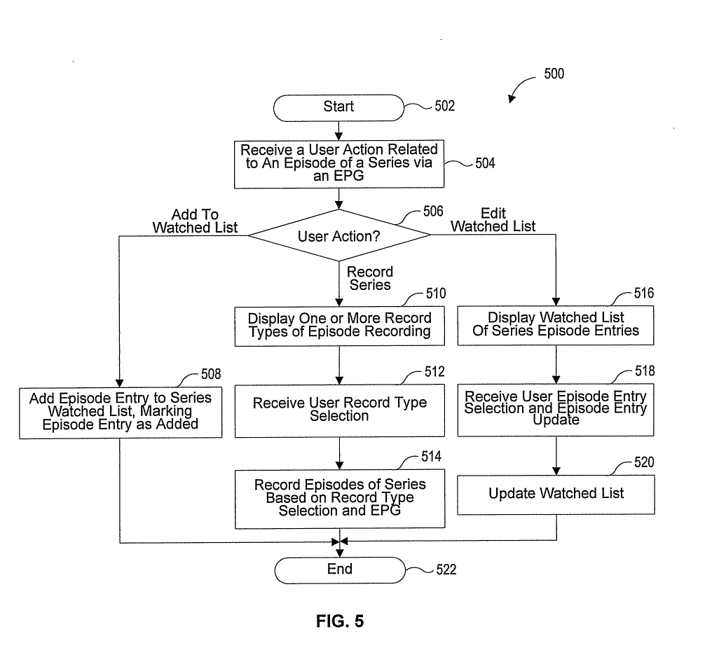

FIG. 5 is a flowchart that illustrates an example method 500 of processing a user action related to a program series of the electronic program guide. The method starts at 502. At 504, a user action related to an episode of a program series is received via an EPG. At 506, a determination is made based on the received user action. If the user action indicates to add the episode to the watched list, then the method 500 continues at 508, where an episode entry related to the episode is added to the series watched list and the episode entry is marked as added. If the user action indicates to record the program series associated with the episode, the method 500 continues at 510, where one or more record types of episode recording are displayed to the user (e.g., new episodes only, new and rerun episodes, or episodes not yet seen). At 512, a user record type selection is received. At 514, episodes of the program series are recorded based on the record type selection and the EPG. If, however, the user action at 506 indicates that the user wished to edit the watched list, then the method 500 continues at 516, where the watched list of episode entries of the program series is displayed. At 518, a selection of an episode entry and an episode entry update are received. At 520, the watched list is updated. The method ends at 522.

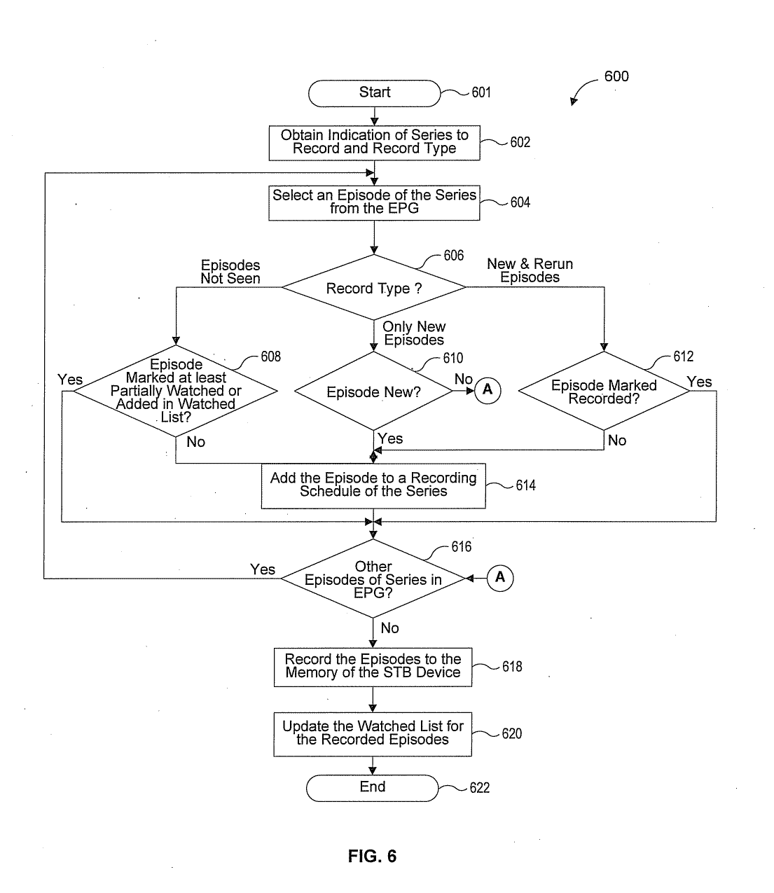

FIG. 6 is a flowchart that illustrates an example method 600 of recording at least one episode of a program series. The particular method illustrated in FIG. 6 is an example of recording, such as that described above at 514 of FIG. 5. The method 600 starts at 601. An indication of a program series to record and a record type of recording are obtained at 602. At 604, an episode of the program series is selected from an EPG. At 606, a determination is made based on the record type (e.g., new episodes only, new and rerun episodes, or episodes not yet seen).

If the record type at 606 indicates to record episodes not seen, then at 608, a determination is made whether the selected episode is marked as at least partially watched or has been added to the watched list for the program series. If the selected episode is not marked as at least partially watched or has not been added to the watched list for the program series, then the method 600 continues at 614. If the selected episode is marked as at least partially watched or has been added to the watched list for the program series, then the method 600 continues at 616.

If the record type at 606 indicates to record only new episodes, then at 610, a determination is made whether the selected episode is new. If the selected episode is new, then the method 600 continues at 614. If the selected episode is not new (e.g., a rerun), then the method 600 continues at 616.

If the record type at 606 indicates to record new and rerun episodes, then at 612, a determination is made whether the selected episode is marked as recorded. If the selected episode is not marked as recorded, then the method 600 continues at 614. If the selected episode is marked as recorded, then the method 600 continues at 616.

At 614, the selected episode is added to a recording schedule of the program series. At 616, a determination is made whether there are other episodes of the program series in the EPG to be processed. If there are other episodes of the program series to be processed, then the method 600 continues at 604. If there are no other episodes of the program series to be processed, then the method continues at 618, where the scheduled episodes are recorded in the memory of the STB device. The watched list of the program series is updated with entries for the recorded episodes at 620. The method 600 ends at 622.

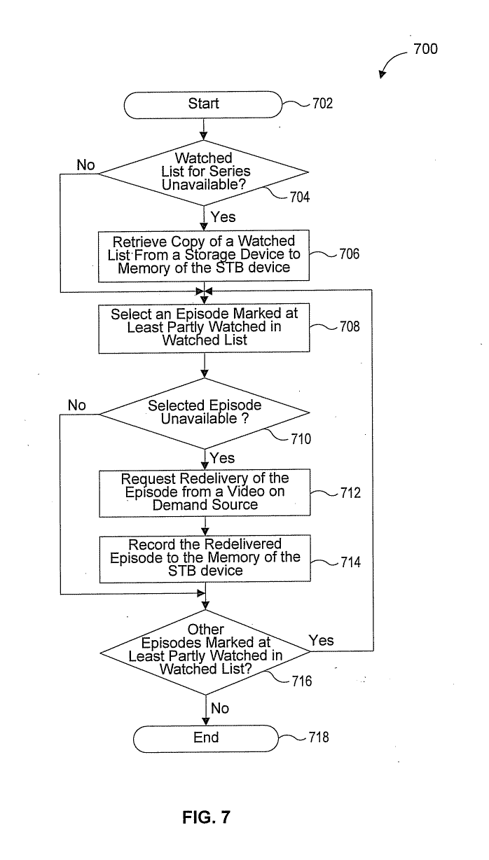

FIG. 7 is a flowchart that illustrates an example method 700 of restoring a watched list and redelivering at least one episode of a program series. The method 700 starts at 702. At 704, a determination is made whether a watched list of a program series is unavailable from the memory of the STB device. If the watched list is available, then the method 700 continues at 708. If the watched list of the program series is unavailable from the memory of the STB device, then at 706, a copy of the watched list is retrieved from a storage device outside of the STB device and stored to the memory of the STB device.

At 708, an episode marked as at least partially watched in the watched list is selected. At 710, a determination is made whether the selected episode is unavailable from the memory of the STB device. If the selected episode is available, then the method 700 continues at 716. If the selected episode is unavailable, then at 712, a redelivery of the selected episode from a video on demand source is requested. At 714, the redelivered episode is recorded to the memory of the STB device.

At 716, a determination is made whether there are other episodes marked as at least partially watched in the watched list. If there are other episodes marked as at least partially watched, the method 700 continues at 708. If there are no other episodes marked as at least partially watched, the method 700 ends at 718.

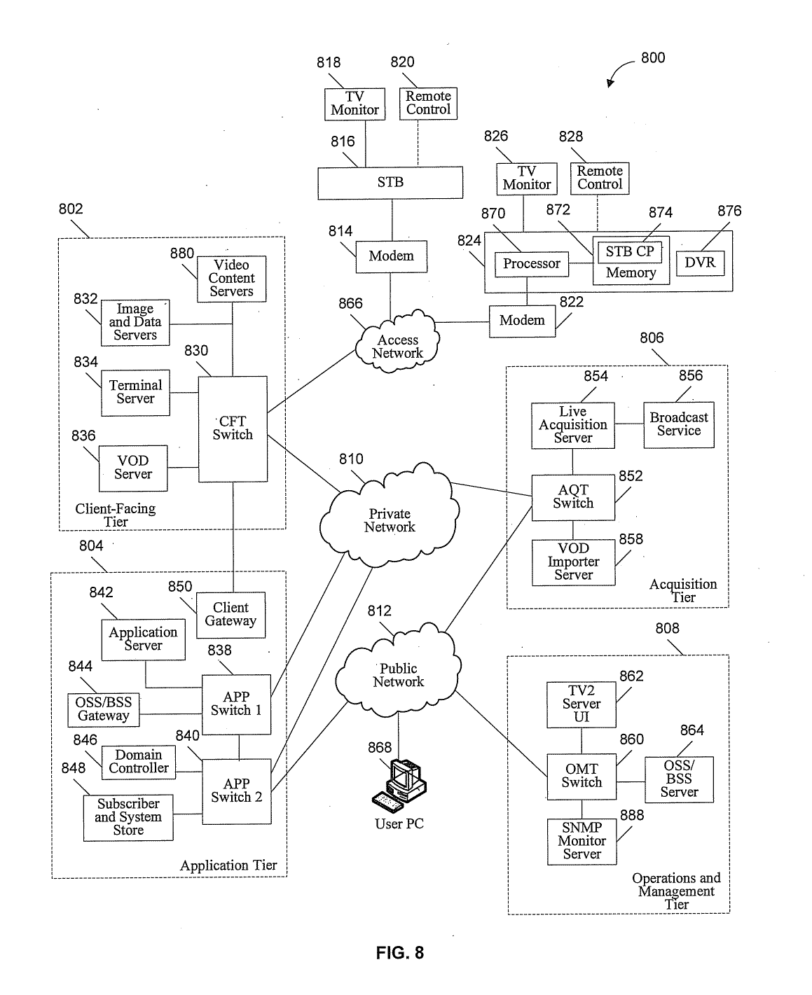

FIG. 8 is an example embodiment of an Internet Protocol Television system 800 that may be used to provide program series content and redelivery thereof to at least one set top box device. As shown, the IPTV system 800 can include a client facing tier 802, an application tier 804, an acquisition tier 806, and an operations and management tier 808. Each tier 802, 804, 806, 808 is coupled to a private network 810; to a public network 812, such as the Internet; or to both the private network 810 and the public network 812. For example, the client-facing tier 802 can be coupled to the private network 810. Further, the application tier 804 can be coupled to the private network 810 and to the public network 812. The acquisition tier 806 can also be coupled to the private network 810 and to the public network 812. Additionally, the operations and management tier 808 can be coupled to the public network 812.

The various tiers 802, 804, 806, 808 communicate with each other via the private network 810 and the public network 812. For instance, the client-facing tier 802 can communicate with the application tier 804 and the acquisition tier 806 via the private network 810. The application tier 804 can also communicate with the acquisition tier 806 via the private network 810. Further, the application tier 804 can communicate with the acquisition tier 806 and the operations and management tier 808 via the public network 812. Moreover, the acquisition tier 806 can communicate with the operations and management tier 808 via the public network 812. In a particular embodiment, elements of the application tier 804, including, but not limited to, a client gateway 150, can communicate directly with the client-facing tier 802.

The client-facing tier 802 can communicate with user equipment via a private access network 866, such as an Internet Protocol Television (IPTV) access network. In an illustrative embodiment, modems, such as a first modem 814 and a second modem 822 can be coupled to the private access network 866. The client-facing tier 802 can communicate with a first representative set top box device 816 via the first modem 814 and with a second representative set top box device 824 via the second modem 822. The client-facing tier 802 can communicate with a large number of set top boxes, such as the representative set top boxes 816, 824, over a wide geographic area, such as a regional area, a metropolitan area, a viewing area, a designated market area or any other suitable geographic area, market area, or subscriber or customer group that can be supported by networking the client-facing tier 802 to numerous set top box devices. In an illustrative embodiment, the client-facing tier, or any portion thereof, can be included at a video head-end office.

In a particular embodiment, the client-facing tier 802 can be coupled to the modems 814, 822 via fiber optic cables. Alternatively, the modems 814 and 822 can be digital subscriber line (DSL) modems that are coupled to one or more network nodes via twisted pairs, and the client-facing tier 802 can be coupled to the network nodes via fiber-optic cables. Each set top box device 816, 824 can process data received via the private access network 866, via an IPTV software platform, such as Microsoft® TV IPTV Edition.

Additionally, the first set top box device 816 can be coupled to a first external display device, such as a first television monitor 818, and the second set top box device 824 can be coupled to a second external display device, such as a second television monitor 826. Moreover, the first set top box device 816 can communicate with a first remote control device 820, and the second set top box device can communicate with a second remote control device 828.

In an example embodiment, each set top box device 816, 824 can receive video content (including episodes of a program series), which may include video and audio portions, from the client-facing tier 802 via the private access network 866. The set top boxes 816, 824 can transmit the video content to an external display device, such as the television monitors 818, 826. Further, the set top box devices 816, 824 can each include a STB processor, such as STB processor 870, and a STB memory device, such as STB memory 872, which is accessible to the STB processor 870. In one embodiment, a computer program, such as the STB computer program 874, can be embedded within the STB,memory device 872. Each set top box device 816, 824 can also include a video content storage module, such as a digital video recorder (DVR) 876. In a particular embodiment, the set top box devices 816, 824 can communicate commands received from the remote control devices 820, 828 to the client-facing tier 802 via the private access network 866.

In an illustrative embodiment, the client-facing tier 802 can include a client-facing tier (CFT) switch 830 that manages communication between the client-facing tier 802 and the private access network 866 and between the client-facing tier 802 and the private network 810. As shown, the CFT switch 830 is coupled to one or more image and data servers 832 that store still images associated with programs of various IPTV channels. The image and data servers 832 can also store data related to various channels, e.g., types of data related to the channels and to programs or video content displayed via the channels. In an illustrative embodiment, the image and data servers 832 can be a cluster of servers, each of which can store still images, channel and program-related data, or any combination thereof. The CFT switch 830 can also be coupled to a terminal server 834 that provides terminal devices with a connection point to the private network 810. In a particular embodiment, the CFT switch 830 can also be coupled to a video-on-demand (VOD) server 836 that stores or provides VOD content imported by the IPTV system 800. The client-facing tier 802 can also include one or more video content servers 180 that transmit video content requested by viewers via their set top boxes 816, 824. In an illustrative, non-limiting embodiment, the video content servers 880 can include one or more multicast servers.

The application tier 804 can communicate with both the private network 810 and the public network 812. The application tier 804 can include a first application tier (APP) switch 838 and a second APP switch 840. In a particular embodiment, the first APP switch 838 can be coupled to the second APP switch 840. The first APP switch 838 can be coupled to an application server 842 and to an OSS/BSS gateway 844. In a particular embodiment, the application server 842 can provide applications to the set top box devices 816, 824 via the private access network 866, which enable the set top box devices 816, 824 to provide functions, such as display, messaging, processing of IPTV data and VOD material, etc. In a particular embodiment, the OSS/BSS gateway 844 includes operation systems and support (OSS) data, as well as billing systems and support (BSS) data. In one embodiment, the OSS/BSS gateway can provide or restrict access to an OSS/BSS server 864 that stores operations and billing systems data.

Further, the second APP switch 840 can be coupled to a domain controller 846 that provides web access, for example, to users via the public network 812. For example, the domain controller 846 can provide remote web access to IPTV account information via the public network 812, which users can access using their personal computers 868. The second APP switch 840 can be coupled to a subscriber and system store 848 that includes account information, such as account information that is associated with users who access the IPTV system 800 via the private network 810 or the public network 812. In a particular embodiment, the application tier 804 can also include a client gateway 850 that communicates data directly with the client-facing tier 802. In this embodiment, the client gateway 850 can be coupled directly to the CFT switch 830. The client gateway 850 can provide user access to the private network 810 and the tiers coupled thereto.

In a particular embodiment, the set top box devices 816, 824 can access the IPTV system 800 via the private access network 866, using information received from the client gateway 850. In this embodiment, the private access network 866 can provide security for the private network 810. User devices can access the client gateway 850 via the private access network 866, and the client gateway 850 can allow such devices to access the private network 810 once the devices are authenticated or verified. Similarly, the client gateway 850 can prevent unauthorized devices, such as hacker computers or stolen set top box devices from accessing the private network 810, by denying access to these devices beyond the private access network 866.

For example, when the first representative set top box device 816 accesses the system 800 via the private access network 866, the client gateway 850 can verify subscriber information by communicating with the subscriber and system store 848 via the private network 810, the first APP switch 838, and the second APP switch 840. Further, the client gateway 850 can verify billing information and status by communicating with the OSS/BSS gateway 844 via the private network 810 and the first APP switch 838. In one embodiment, the OSS/BSS gateway 844 can transmit a query across the first APP switch 838, to the second APP switch 840, and the second APP switch 840 can communicate the query across the public network 812 to the OSS/BSS server 864. After the client gateway 850 confirms subscriber and/or billing information, the client gateway 850 can allow the set top box device 816 access to IPTV content and VOD content. If the client gateway 850 cannot verify subscriber information for the set top box device 816, e.g., because it is connected to an unauthorized twisted pair, the client gateway 850 can block transmissions to and from the set top box device 816 beyond the private access network 166.

The acquisition tier 806 includes an acquisition tier (AQT) switch 852 that communicates with the private network 810. The AQT switch 852 can also communicate with the operations and management tier 108 via the public network 812. In a particular embodiment, the AQT switch 852 can be coupled to a live acquisition server 854 that receives television or movie content, for example, from a broadcast service 856. In a particular embodiment during operation of the IPTV system, the live acquisition server 854 can acquire television or movie content. The live acquisition server 854 can transmit the television or movie content to the AQT switch 852, and the AQT switch 852 can transmit the television or movie content to the CFT switch 830 via the private network 110.

Further, the television or movie content can be transmitted to the video content servers 880, where it can be encoded, formatted, stored, or otherwise manipulated and prepared for communication to the set top box devices 816, 824. The CFT switch 830 can communicate the television or movie content to the modems 814, 822 via the private access network 166. The set top box devices 816, 824 can receive the television or movie content via the modems 814, 822, and can transmit the television or movie content to the television monitors 818, 826. In an illustrative embodiment, video or audio portions of the television or movie content can be streamed to the set top box devices 816, 824.

Further, the AQT switch can be coupled to a video-on-demand importer server 858 that stores television or movie content received at the acquisition tier 806 and communicates the stored content to the VOD server 836 at the client-facing tier 802 via the private network 810. Additionally, at the acquisition tier 806, the video-on-demand (VOD) importer server 858 can receive content from one or more VOD sources outside the IPTV system 800, such as movie studios and programmers of non-live content. The VOD importer server 858 can transmit the VOD content to the AQT switch 852, and the AQT switch 852, in turn, can communicate the material to the CFT switch 830 via the private network 810. The VOD content can be stored at one or more servers, such as the VOD server 836.

When user issue requests for VOD content (e.g., redelivery requests for episodes of program series) via the set top box devices 816, 824, the requests can be transmitted over the private access network 866 to the VOD server 836, via the CFT switch 830. Upon receiving such requests, the VOD server 836 can retrieve the requested VOD content and transmit the content to the set top box devices 816, 824 across the private access network 866, via the CFT switch 830. The set top box devices 816, 824 can transmit the VOD content to the television monitors 818, 826. In an illustrative embodiment, video or audio portions of VOD content can be streamed to the set top box devices 816, 824.

FIG. 8 further illustrates that the operations and management tier 808 can include an operations and management tier (OMT) switch 860 that conducts communication between the operations and management tier 808 and the public network 812. In the embodiment illustrated by FIG. 8, the OMT switch 860 is coupled to a TV2 server 862. Additionally, the OMT switch 860 can be coupled to an OSS/BSS server 864 and to a simple network management protocol (SNMP) monitor 870 that monitors network devices within or coupled to the IPTV system 800. In a particular embodiment, the OMT switch 860 can communicate with the AQT switch 852 via the public network 812.

In an illustrative embodiment, the live acquisition server 854 can transmit the television or movie content to the AQT switch 852, and the AQT switch 852, in turn, can transmit the television or movie content to the OMT switch 860 via the public network 812. In this embodiment, the OMT switch 860 can transmit the television or movie content to the TV2 server 862 for display to users accessing the user interface at the TV2 server 862. For example, a user can access the TV2 server 862 using a personal computer (PC) 868 coupled to the public network 812.

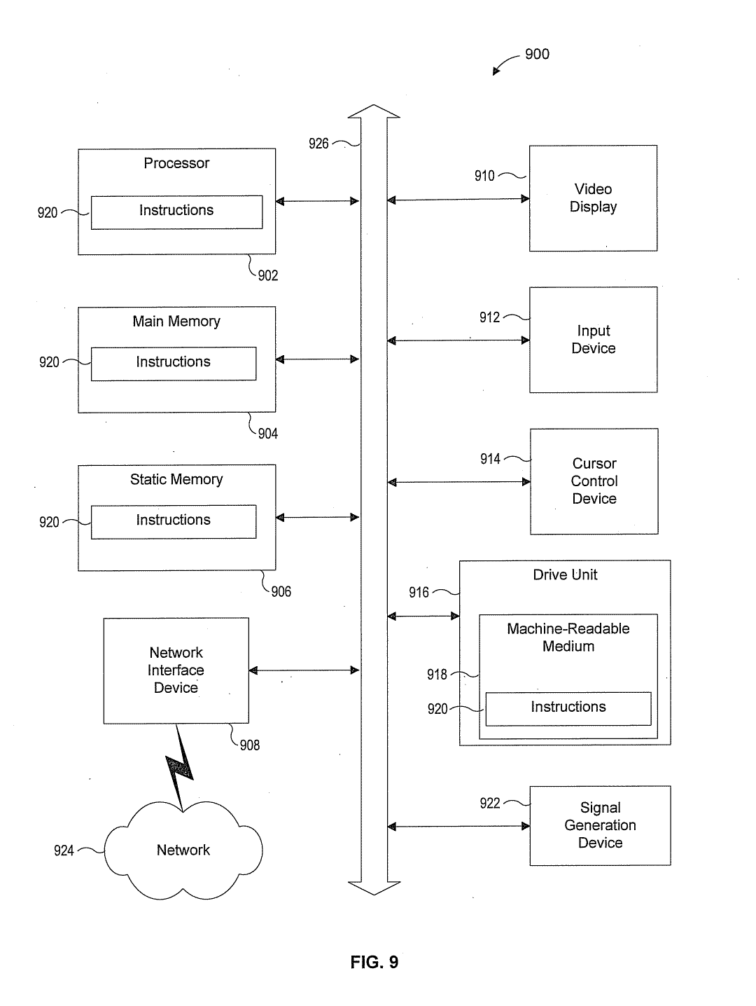

FIG. 9 illustrates an example embodiment of a general computer system 900. The computer system 900 can include a set of instructions that can be executed to cause the computer system 900 to perform any one or more of the methods or computer based functions disclosed herein. The computer system 900, or any portion thereof, may operate as a standalone device or may be connected, e.g., using a network, to other computer systems or peripheral devices.

In a networked deployment, the computer system 900 may operate in the capacity of an Internet Protocol television (IPTV) server, such as a video server or application server, or a set top box device. The computer system 900 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics-processing unit (GPU), or both. Moreover, the computer system 900 can include a main memory 904 and a static memory 906 that can communicate with each other via a bus 926. As shown, the computer system 900 may further include a video display unit 910, such as a liquid crystal display (LCD), an organic light emitting diode (OLED), a projection unit, a television, a flat panel display, a solid state display, or a cathode ray tube (CRT). Additionally, the computer system 900 may include an input device 912, such as a keyboard, and a cursor control device 914, such as a mouse. The computer system 900 can also include a disk drive unit 916, a signal generation device 922, such as a speaker or remote control device, and a network interface device 908.

In a particular embodiment, as depicted in FIG. 9, the disk drive unit 916 may include a computer-readable medium 918 in which one or more sets of instructions 920, e.g., software, can be embedded. Further, the instructions 920 may embody one or more of the methods or logic as described herein. In a particular embodiment, the instructions 920 may reside completely, or at least partially, within the main memory 904, the static memory 906, and/or within the processor 902 during execution by the computer system 900. The main memory 904 and the processor 902 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs tangibly embodied in a processor-readable medium and may be executed by a processor. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 920 or receives and executes instructions 920 responsive to a propagated signal, so that a device connected to a network 924 can communicate voice, video or data over the network 924. Further, the instructions 920 may be transmitted or received over the network 924 via the network interface device 908.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a medium that is equivalent to a tangible storage medium. Accordingly, the disclosure is considered to include any one or more of a computer-readable medium and other equivalents and successor media, in which data or instructions may be stored.

Although the present specification describes components and functions that may be implemented in particular embodiments with reference to particular standards and protocols, the invention is not limited to such standards and protocols. Such standards and protocols are periodically superseded by faster or more efficient equivalents having essentially the same functions. Accordingly, replacement standards and protocols having the same or similar functions as those disclosed herein are considered equivalents thereof.

Thus, systems, methods and computer-readable storage media to provide recordation of program series have been described. Although specific example embodiments have been described, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments and other embodiments not specifically described herein, will be apparent to those of skill in the art upon reviewing the above description.

The Abstract is provided to comply with 37 C.F.R. §1.72(b) and will allow the reader to quickly ascertain the nature of the technical disclosure. It is submitted with the understanding that it will not be used to interpret or limit the scope or meaning of the claims.

In the foregoing description of the embodiments, various features may be grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment.

What is claimed is:

1. A method of recording programs via a set top box (STB) device, the method comprising:
obtaining a record type indication related to a program series from a user via an electronic program guide (EPG);
accessing a watched list of episodes of the program series from a memory of the STB device to determine episodes of the program series that the user has not seen, including episodes of the program series that are marked as not watched or episodes that have not been added to the watched list;
recording at least one episode of the program series based on the determination; and
updating the watched list to mark that the at least one episode has been recorded.

2. The method of recording of claim 1, wherein recording at least one episode includes:
adding the at least one episode to a recording schedule associated with the program series; and
recording the at least one episode based on the recording schedule.

3. The method of recording of claim 1, further comprising:
retrieving the watched list from an external storage device when the watched list is unavailable from the memory of the STB device; and
storing the retrieved watched list to the memory of the STB device.

4. The method of recording of claim 1, further comprising:
selecting an episode of the program series marked at least partially watched from the watched list;
re-delivering the selected episode from a content video source when the selected episode is unavailable from the memory of the STB device; and
storing the re-delivered episode to the memory of the STB device.

5. The method of recording of claim 1, further comprising:
adding an entry to the watched list associated with an episode of the program series; and
marking the entry for the episode as added; and
blocking recording of the episode of the program series based on the associated entry of the watched list.

6. The method of recording of claim 3, wherein retrieving the watched list includes retrieving the watched list from a memory of a remote control device.

7. The method of recording of claim 5, further comprising:
receiving from a user a selection of an episode entry in the watched list and an update associated with the episode entry; and
updating the watched list with the update.

8. The method of recording of claim 7, wherein the update includes a delete instruction, and updating the watched list includes deleting the added entry in accordance with the delete instruction.

9. A set top box (STB) device to record a program, the STB device comprising:
a memory to store episodes of a program series, the memory to further store a watched list associated with the episodes of the program series;
an episode manager configured to:
obtain a record type indication related to the program series from a user via an electronic program guide;
access the watched list associated with episodes of the program series from the memory to determine episodes of the program series that the user has not seen, including episodes of the program series that are marked as not watched or episodes that have not been added to the watched list; and
update the watched list to mark at least one episode of the program series when it is recorded; and
a video recording module to record the at least one episode of the program series based on the episode manager determining episodes of the program series that the user has not seen.

10. The STB device of claim 9, wherein the episode manager is further configured to:
retrieve the watched list from a storage device external to the STB device when the watched list is unavailable from the memory; and
store the retrieved watched list to the memory.

11. The STB device of claim 9,
wherein the episode manager is further configured to:
select an episode of the program series marked at least partially watched from the watched list; and
request redelivery of the selected episode when selected episode is unavailable from the memory; and
wherein the STB device further comprises:
an episode redelivery module to redeliver the selected episode from a content video source to the episode manager based on the episode manager requesting redelivery.

12. The STB device of claim 9, further comprising a recording scheduling module to store an indication of the at least one episode of the program series in a recording schedule, wherein the video recording module is to record the at least one episode of the program series indicated in the recording schedule.

13. The STB device of claim 12,
wherein the episode manager is further configured to:
add an entry to the watched list for an episode of the program series; and
mark the entry for the episode as added; and
wherein the recording scheduling module is further configured to block recording of the episode of the program series based on the associated entry in the watched list.

14. The STB device of claim 10, wherein the storage device external to the STB device is a memory of a remote control device.

15. The STB device of claim 12, wherein the episode manager is further configured to:
receive from a user a selection of an episode entry in the watched list and an update associated with the entry; and
update the watched list with the update.

16. The STB device of claim 15, wherein the update includes a delete instruction, wherein the episode manager is further configured to delete the added entry in accordance with the delete instruction.

17. A computer-readable storage medium comprising operational instructions that, when executed by a processor, cause the processor to:
obtain a record type indication related to a program series from a user via an electronic program guide (EPG);
access a watched list of episodes of the program series from a memory of an STB device to determine episodes of the program series that the user has not seen, including episodes of the program series that are marked as not watched or episodes that have not been added to the watched list;
record at least one episode of the program series based on the determination; and
update the watched list to mark that the at least one episode has been recorded.

18. The computer-readable storage medium of claim 17, wherein the operational instructions that, when executed by the processor, cause the processor to record at least one episode further include operational instructions to:
add the at least one episode to a recording schedule associated with the program series; and
record the at least one episode based on the recording schedule.

19. The computer-readable storage medium of claim 17, further comprising operational instructions that, when executed by a processor, cause the processor to:
retrieve the watched list from an external storage device when the watched list is unavailable from the memory of the STB device; and
store the retrieved watched list to the memory of the STB device.

20. The computer-readable storage medium of claim 17, further comprising operational instructions that, when executed by a processor, cause the processor to:
select an episode of the program series marked at least partially watched from the watched list;
re-deliver the selected episode from a content video source when the selected episode is unavailable from the memory of the STB device; and
store the re-delivered episode to the memory of the STB device.

21. The computer-readable storage medium of claim 17, further comprising operational instructions that, when executed by a processor, cause the processor to:
add an entry to the watched list associated with an episode of the program series; and
mark the entry for the episode as added; and
block recording of the episode of the program series based on the associated entry of the watched list.

22. The computer-readable storage medium of claim 19, wherein the operational instructions that, when executed by the processor, cause the processor to retrieve the watched list further include operational instructions to retrieve the watched list from a memory of a remote control device.

23. The computer-readable storage medium of claim 21, further comprising operational instructions that, when executed by a processor, cause the processor to:
receive from the user a selection of an episode entry in the watched list and an update associated with the episode entry; and
update the watched list with the update.

24. The computer-readable storage medium of claim 23, wherein the operational instructions that, when executed by the processor, cause the processor to update the watched list further include operational instructions that, when executed by a processor, cause the processor to delete the added entry in accordance with the update.
